(19) United States
(12) Patent Application Publication
(10) Pub. No.: US 2006/0270370 A1
(43) Pub. Date: Nov. 30, 2006

(54) Radio receiver and reserved band filter

(76) Inventor: Michael Bergman, Princeton Junction, NJ (US)

Correspondence Address: ERIC ROBINSON, PMB 955, 21010 SOUTHBANK ST., POTOMAC FALLS, VA, 20165, US

(21) Appl. No.: 11/139,792

(22) Filed: May 31, 2005

(51) Int. Cl. H04B 1/18

(52) U.S. Cl. 455/188.1; 455/180.1

(57) ABSTRACT

A radio receiver or a filter circuit for an FM radio receiver, the radio receiver or the filter circuit having a first radio frequency (RF) or band pass filter, which may be selectively electrically or operatively connected between an input and a mixer when a tuner is tuned to a first RF range, or which may be for passing a first RF range, and a second RF or band pass filter, which may be selectively electrically connected between the input and the mixer when the tuner is tuned to a second RF range, or which may be for passing a second RF range different from the first RF range. The filter circuit may have a control circuit selectively electrically or operatively connected with the first RF filter and the second RF filter for inserting the first RF filter into a signal path when the FM radio receiver is tuned.

### BACKGROUND OF THE INVENTION

Although developed in the late 1930s, frequency modulated (FM) radio remains a popular form of communication and entertainment. In the United States, there are about 6,200 FM commercial radio stations, about 2,500 FM educational radio stations (2004) and about 575 million radios (1997).

Officially, the FM broadcast frequency band in the U.S. starts at 88 MHz and ends at 108 MHz. In practice, the band is divided into 101 channels (Channels 200 through 300), each 200 kHz (0.2 MHz) wide, starting with 87.9 MHz (Channel 200) and progressing at 200 KHz (0.2 MHz) intervals up to and including 107.9 MHz (Channel 300).

Although not well known by the public, in the U.S., the Federal Communications Commission (FCC) differentiates between public or noncommercial educational FM radio broadcasting and private or commercial FM radio broadcasting. Specifically, the FCC has mandated a reserved band for noncommercial educational FM broadcasting which includes frequencies between about 87.9 MHz (Channel 200) and 91.9 MHz (Channel 220). With limited exceptions, the reserved band is used by noncommercial radio stations consisting of public, college, community, and other noncommercial radio stations. Commercial FM radio stations, which broadcast at frequencies between about 92.1 MHz (Channel 221) and about 107.9 MHz (Channel 300), are mostly precluded from broadcasting in the reserved band.

Many public radio stations in the U.S. are publicly funded, for instance, stations that are owned by local colleges or universities. Due to the comparatively high cost of high power FM radio transmission, many public radio stations in the U.S. are comparatively low power stations, that is less than 20 KW effective radiated power (ERP), or even less than 1 KW ERP. Also, the FCC has created Low Power FM (LPFM) radio service and has defined LPFM as stations authorized for noncommercial educational broadcasting only (no commercial operation) which operate with an ERP of 100 watts (0.1 kilowatts) or less, with maximum facilities of 100 watts ERP at 30 meters (100 feet) antenna height above average terrain (HAAT). The approximate service range of a 100 watt LPFM station is 5.6 kilometers (3.5 miles radius). As specifically noted by the FCC, LPFM stations are not protected from interference that may be received from other classes of FM stations.

In contrast, it is common to find a high power commercial FM radio station, for example 50 KW to 100 KW, in major U.S. markets. As a result of high power commercial FM radio stations operating in the same metropolitan area, many low power FM radio stations using the reserved band are often overpowered by the commercial stations and have reception issues.

Prior art radio receivers typically have a basic design as follows: a band pass (or band select) filter which operates in a broad frequency range, for example 87.9 MHz to 107.9 MHz in the U.S., followed by a mixer, and followed by a channel-select filter. FIG. 5 shows a block diagram of a front end of a conventional AM/FM radio RF receiver 10. The term “front end” as used in this application refers to the portion of a radio receiver between a signal input device, such as an antenna, and an intermediate frequency (IF) device for intermediate frequency stage downconversion. The front end of the radio receiver 10 comprises a signal input 20 connected to an AM receiver circuit 12 and an FM receiver circuit 14. AM receiver circuit 12 comprises an AM band pass filter 30 connected to the signal input 20, an AM PIN diode detector 40 connected to the AM band pass filter 30, an AM variable gain amplifier 50 connected to the AM PIN diode detector 40, an AM band pass filter 60 connected to the AM variable gain amplifier 50, an AM amplifier 70 connected to the AM band pass filter 60, where the AM amplifier 70 is also connected to the AM PIN diode detector 40 and the AM variable gain amplifier 50 in a feedback loop, and an AM mixer 80 connected to the AM band pass filter 60. FM receiver circuit 14 comprises an FM band high pass filter 100 connected to the signal input 20, an FM PIN diode detector 110 connected to the FM band high pass filter 100, an FM band pass filter 120 connected to the FM PIN diode detector, an FM amplifier 130 connected to the FM band pass filter 120, where the FM amplifier 130 is also connected to the FM PIN diode detector 110 in a feedback loop, and an FM mixer 140 connected to the FM band pass filter 120. An IF output 90 is connected to the AM mixer 80 and the FM mixer 140, and a voltage controlled oscillator (VCO) 150 is connected to the AM mixer 80 and the FM mixer 140. Also required are a tuner 160 shown connected to the VCO 150. In the conventional radio receiver 10, the FM band pass filter 120 is between the signal input 20 and the IF output 90, and the FM band pass filter 120 is adapted to receive the full range of the FM band from 87.9 MHz to 107.9 MHz.

A problem occurs in the reception of signals from lower power FM radio stations using prior art radio receivers such as the radio receiver 10 described above. Specifically, when prior art FM radio receivers are tuned to a frequency in the reserved band, the radio receiver may be desensitized by a signal from a high power commercial FM radio station and unable to receive a signal from a lower power noncommercial FM radio station, or the front end of the receiver can be saturated by the high power commercial FM radio station. It is noted that the lower power FM radio stations described above refer to a group which includes LPFM stations as defined by the FCC and also may include other lower power stations that may not qualify as an LPFM station as defined by the FCC. Prior art radio receivers may be equipped with a filter for a desired station, but such filtering occurs after the first mixer, amplifier and automatic gain control (AGC) stages, that is after IF downconversion. Although it is possible to improve the performance of a radio receiver by filtering out each undesired station, it is not practical or economical. There are 101 possible FM station frequency allocations in the U.S. FM band, and it is not feasible to provide a filter for each station in the radio receiver.

### BRIEF SUMMARY OF THE INVENTION

The present invention is directed to a radio receiver comprising a first band pass (or band select) filter selectively electrically or operatively connected between an input and a mixer when a tuner is tuned to a first radio frequency range, and a second band pass filter selectively electrically or operatively connected between the input and the mixer when the tuner is tuned to a second radio frequency range. The second band pass filter may be adapted to filter out commercial radio broadcasting.

Also, the present invention is directed to a method for receiving a radio signal comprising the steps of selectively connecting a first band pass filter between an input and a mixer when a tuner is tuned to a first radio frequency range, and selectively connecting a second band pass filter between the input and the mixer when the tuner is tuned to a second radio frequency range.

Further, the present invention is directed to a filter circuit for an FM radio receiver comprising a first radio frequency or band pass filter for passing a first radio frequency range, a second radio frequency or band pass filter for passing a second radio frequency range different from the first radio frequency range, and a control circuit selectively electrically or operatively connected with the first radio frequency filter and the second radio frequency filter for inserting the first radio frequency filter into a signal path when the FM radio receiver is tuned to a frequency in the first radio frequency range and for inserting the second radio frequency filter into the signal path when the FM radio receiver is turned to a frequency in the second radio frequency range.

Still further, the present invention is directed to a means for receiving an FM radio signal comprising a first means for filtering the FM radio signal selectively electrically or operatively connected between a means for inputting the FM radio signal and a means for mixing the FM radio signal when a means for tuning the receiving means is tuned to a first radio frequency range, and a second means for filtering the FM radio signal selectively electrically or operatively connected between the means for inputting the FM radio signal and the means for mixing the FM radio signal when the means for tuning the receiving means is tuned to a second radio frequency range.

An object of the present invention is to provide a filter, a filter circuit or a receiver for improved reception of a radio signal.

Another object of the present invention is to provide a filter, a filter circuit or a receiver for improved reception of a signal from a public or noncommercial radio station.

A further object of the present invention is to provide a filter, a filter circuit or a receiver for improved reception of a signal from a public or noncommercial FM radio station.

Still another object of the present invention is to provide a filter, a filter circuit or a receiver for improved reception of a signal from a radio station broadcasting in a reserved band, where the reserved band may be one which is reserved for public or noncommercial radio broadcasting.

An even further object of the present invention is to provide a filter, a filter circuit or a receiver for improved reception of a signal from a public or noncommercial FM radio station broadcasting in a reserved band between frequencies centered about 87.9 MHz and frequencies centered about 91.9 MHz.

Yet another object of the present invention is to provide a filter, a filter circuit or a receiver for improved reception of a signal from a public or noncommercial FM radio station broadcasting in Channels 200 through 220.

An object of the present invention is to provide a filter, a filter circuit or a receiver for improved reception of a radio signal where the filter operates before an intermediate frequency stage of the radio receiver or before intermediate frequency downconversion or between an input and an intermediate frequency stage input.

Another object of the present invention is to provide a filter, a filter circuit or a receiver for improved reception of a radio signal where a first radio frequency range passed by a first filter is directly adjacent to or at least partially overlaps with a second radio frequency range passed by a second filter.

A further object of the present invention is to provide a filter, a filter circuit or a receiver for improved reception of a radio signal with a tuner selectively electrically or operatively connected to first and second band pass filters and which operates such that the first band pass filter selectively electrically connects between an input and a mixer when the tuner is tuned to a first radio frequency range, and such that the second band pass filter selectively electrically connects between the input and the mixer when the tuner is tuned to a second radio frequency range.

Still another object of the present invention is to provide a filter, a filter circuit or a receiver for improved reception of a radio signal where a control circuit comprises a switch electrically connected between an RF signal source and each of an input of a first radio frequency or band pass filter and an input of a second radio frequency filter.

An even further object of the present invention is to provide a filter, a filter circuit or a receiver for improved reception of a radio signal where a control circuit comprises a switch electrically connected between an RF signal source and an input of a first radio frequency or band pass filter, and where a second radio frequency or band pass filter is electrically connected between the RF signal source and the control circuit.

Yet another object of the present invention is to provide a filter, a filter circuit or a receiver for improved reception of a radio signal where an RF signal source is an antenna.

### BRIEF DESCRIPTION OF THE DRAWINGS

FIG. 1 shows a block diagram of a front end of an AM/FM radio RF receiver of the present invention.

FIG. 2 shows a portion of a block diagram of a front end of an AM/FM radio RF receiver of the present invention, an FM band pass filter for a first range of frequencies, and a reserved FM band pass filter for a second range of frequencies where the first and second ranges overlap.

FIG. 3 shows a portion of a block diagram of a front end of an AM/FM radio RF receiver of the present invention, an FM band pass filter for a first range of frequencies, and a reserved FM band pass filter for a second range of frequencies where the first and second ranges overlap, and where the signal is amplified and then passes through one or both of the FM band pass filters.

FIG. 4 shows a portion of a block diagram of a front end of an AM/FM radio RF receiver of the present invention, an FM band pass filter for a first range of frequencies, and a reserved FM band pass filter for a second range of frequencies where the first and second ranges are adjacent and do not overlap.

FIG. 5 shows a block diagram of a front end of a conventional AM/FM radio RF receiver.

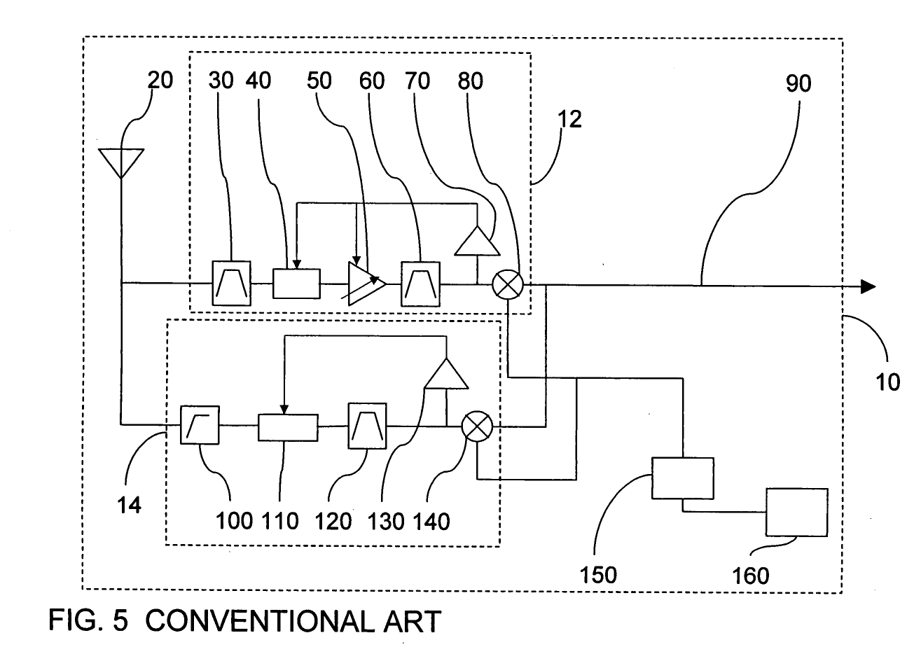

### DETAILED DESCRIPTION OF THE INVENTION

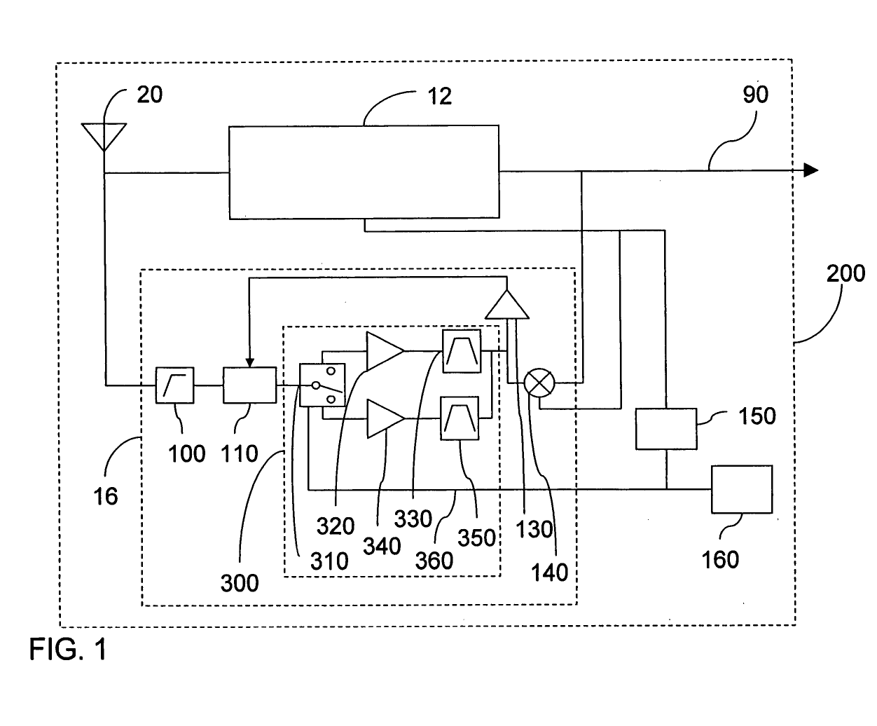

FIG. 1 shows one embodiment of the present invention, particularly adapted for operation in the U.S. Specifically, FIG. 1 shows a block diagram of a front end of an AM/FM radio RF receiver 200. The front end of the radio receiver 200 may comprise a signal input 20 connected to an AM receiver circuit 12 and an FM receiver circuit 16. The FM receiver circuit 16 may comprise the following features: an FM band high pass filter 100 connected to the signal input 20, an FM PIN diode detector 110 connected to the FM band high pass filter 100, a filter circuit 300 connected to the FM PIN diode detector 110, an FM amplifier 130 connected to the filter circuit 300, where the FM amplifier may also be connected to the FM PIN diode detector 110 in a feedback loop, and an FM mixer 140 connected to the filter circuit 300. An IF output 90 may be connected to the AM receiver circuit 12 and the FM receiver circuit 16. Also, a voltage controlled oscillator (VCO) 150 may be connected to the AM receiver circuit 12 and the FM receiver circuit 16, and a tuner 160 may be connected to the VCO 150 and the filter circuit 300. In the radio receiver 200, the filter circuit 300 may be preferably placed between the signal input 20 and the IF output 90. In other words, the filter circuit 300 may be adapted to function prior to IF downconversion. It is also noted that in the embodiments described in the present application, the filter circuit 300 may be adapted for any suitable location within the receiver. For example, the filter circuit 300 of the present invention may be adapted for use before or after a gain stage or before or after other generally interchangeable components or functions of the receiver.

In another embodiment of the present invention, the filter circuit 300 may be adapted for an FM radio receiver, such as receiver 200. The filter circuit 300 may comprise a first radio frequency or band pass filter 330 for passing a first radio frequency range. The filter circuit 300 may further comprise a second radio frequency filter 350 for passing a second radio frequency range different from the first radio frequency range. The filter circuit 300 may further comprise a control circuit 310 selectively electrically or operatively connected with the first radio frequency filter 330 and the second radio frequency filter 350 for inserting the first radio frequency filter 330 into a signal path when the FM radio receiver is tuned to a frequency in the first radio frequency range and for inserting the second radio frequency filter into the signal path when the FM radio receiver is turned to a frequency in the second radio frequency range. The control circuit 310 may comprise a switch electrically connected between an RF signal source 20 and each of an input of the first radio frequency filter 330 and an input of the second radio frequency filter 350. The RF signal source 20 may be an antenna.

The filter circuit 300 may preferably be adapted to selectively receive the full FM band and to selectively receive the reserved FM band. Alternately, the filter circuit 300 may be adapted to selectively receive the commercial FM band only and to selectively receive the reserved FM band only. Again, it is noted that the “reserved FM band” refers to the noncommercial or public portion of the FM band.

The filter circuit 300 may preferably be adapted to selectively receive the full FM band from frequencies centered about 87.9 MHz to frequencies centered about 107.9 MHz and to selectively receive the reserved FM band from frequencies centered about 87.9 MHz to frequencies centered about 91.9 MHz. Alternately, the filter circuit 300 may be adapted to selectively receive the commercial FM band from frequencies centered about 92.1 MHz to frequencies centered about 107.9 MHz and to selectively receive the reserved FM band from frequencies centered about 87.9 MHz to frequencies centered about 91.9 MHz.

As noted above, the FM band is divided into 101 channels (Channels 200 through 300), each 200 kHz (0.2 MHz) wide, starting with 87.9 MHz (Channel 200) and progressing at 200 KHz (0.2 MHz) intervals up to and including 107.9 MHz (Channel 300). As such, for example, Channel 200 is centered on 87.9 MHz and includes 100 KHz to either side, that is about 87.8 MHz to about 88.0 MHz. Therefore, the filter circuit 300 may preferably be adapted to selectively receive the full FM band from about 87.8 MHz to about 108.0 MHz and to selectively receive the reserved FM band from about 87.8 MHz to about 92.0 MHz. It is noted that in practice, a receiver is designed to add a little to the frequency range, because a filter may have problems at the band edge. In other words, the actual range may be a little wider than the precise range noted above. As such, the range may be expressed using the term “about” to account for the additional range provided for the above-referenced concern with problems at the band edge. Alternately, the filter circuit 300 may be adapted to selectively receive the commercial FM band from about 92.0 MHz to about 108.0 MHz and to selectively receive the reserved FM band from about 87.8 MHz to about 92.0 MHz.

Also, the filter circuit 300 may preferably be adapted to selectively receive the full FM band from Channel 200 through Channel 300 and to selectively receive the reserved FM band from Channel 200 through Channel 220. Alternately, the filter circuit 300 may be adapted to selectively receive the commercial FM band from Channel 221 through Channel 300 and to selectively receive the reserved FM band from Channel 200 through Channel 220.

In a further embodiment of the present invention, the filter circuit 300 may comprise a control circuit 310 connected to an input device. The control circuit 310 may be connected to a signal input 20 via the FM band high pass filter 100 and the FM PIN diode detector 110. A first FM amplifier 320 may be connected to the control circuit 310, and a first FM band pass filter 330 may be connected to the first FM amplifier 320. A second FM amplifier 340 may be connected to the control circuit 310, and a second band pass filter 350 may be connected to the second FM amplifier 340. The first and second band pass filters 330, 350 are connected to an output device. The first and second band pass filters 330, 350 may be connected to an IF output 90 via the FM mixer 140.

The first band pass filter 330 may be adapted to pass a first radio frequency range 410 or 415 and may be selectively electrically or operatively connected between the input 20 and the mixer 140. The second band pass filter 350 may be adapted to pass a second radio frequency range 420 and may be selectively electrically or operatively connected between the input 20 and the mixer 140. The tuner 160 may be selectively electrically or operatively connected to the first and second band pass filters 330, 350 and which operates such that the first band pass filter 330 selectively electrically connects between the input 20 and the mixer 140 when the tuner 160 is tuned to the first radio frequency range 410 or 415, and such that the second band pass filter 350 selectively electrically connects between the input 20 and the mixer 140 when the tuner 160 is tuned to the second radio frequency range 420. The second radio frequency range 420 may be a reserved band intended to carry a signal from a lower power station or from a public or noncommercial FM radio station.

The first and second band pass filters 330, 350 may operate before an intermediate frequency stage of the radio receiver or between an input and an intermediate frequency stage input. In other words, the first and second band pass filters 330, 350 may operate before intermediate frequency downconversion via the IF output 90 or between an input such as signal input 20 and an intermediate frequency stage input, such as that which connects to IF output 90. In this fashion, interference to the receiver front end from a nearby high power transmitter can be minimized or eliminated.

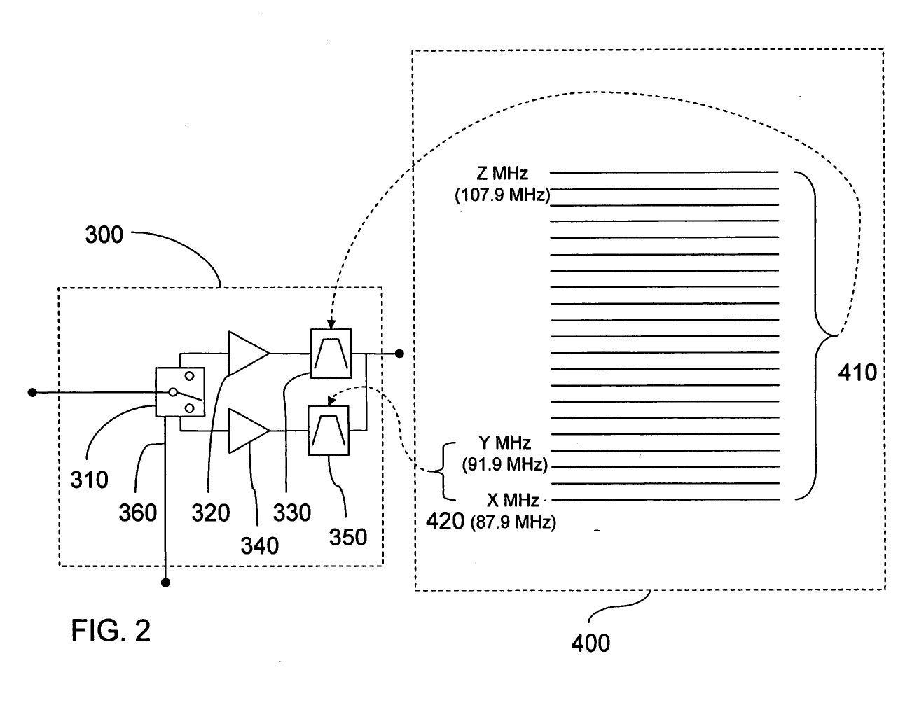

As shown in FIG. 2, the first band pass filter 330 may be adapted to pass lower frequencies X-Y MHz and higher frequencies Y-Z MHz, and the second band pass filter 350 may be adapted to pass lower frequencies X-Y MHz and to exclude higher frequencies Y-Z MHz, where X<Y<Z. In other words, an upper limit Z MHz of the first radio frequency range 410 passed by the first band pass filter 330 may be higher than an upper limit Y MHz of the second radio frequency range 420 passed by the second band pass filter 350.

For example, the second radio frequency range 420 may be between frequencies centered about 87.9 MHz (X) and frequencies centered about 91.9 MHz (Y), or between about 87.8 MHz and about 92.0 MHz, which corresponds with the reserved or noncommercial FM band or Channels 200 through 220, and the first radio frequency range 410 may be between frequencies centered about 87.9 MHz (X) and frequencies centered about 107.9 MHz (Z), or between about 87.8 MHz and about 108.0 MHz, which corresponds with the entire FM band or Channels 200 through 300.

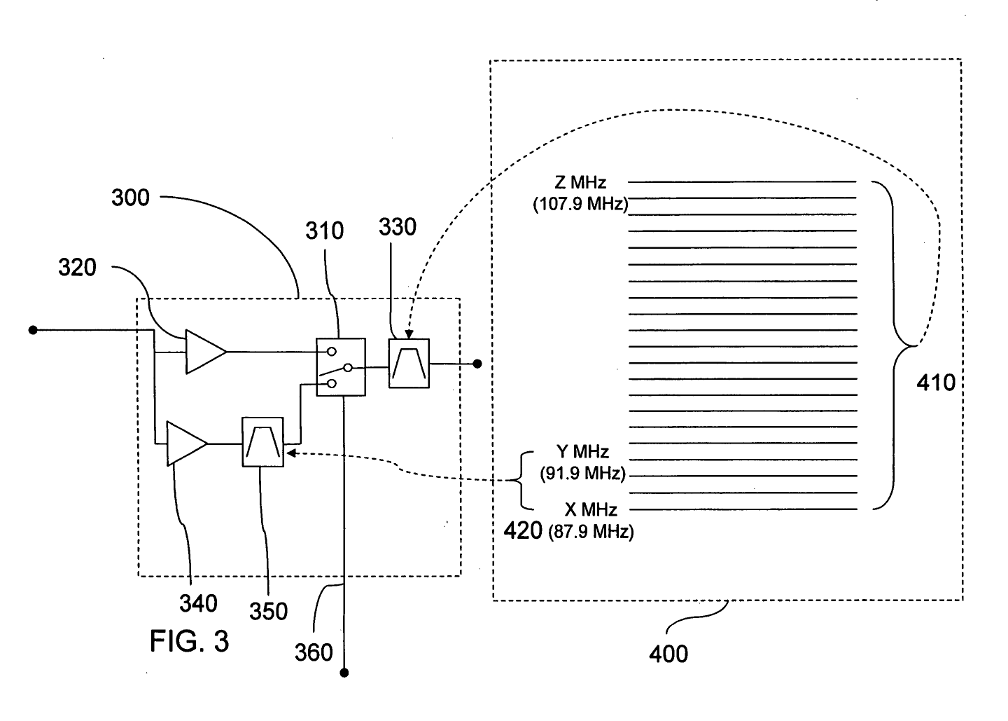

Alternately, as shown in FIG. 3, the filter circuit 100 comprises a first FM amplifier 320 connected to an input of a control circuit 310, and a second FM amplifier 340 connected to the input of the control circuit 310, where a second band pass filter 350 is connected between the second FM amplifier 340 and the input of control circuit 310, and where a first band pass filter 330 is connected to an output of the control circuit 310. The filter circuit 300 operates such that a signal passes only through the first band pass filter 330, or a signal passes first through the second band pass filter 350 and then passes through the first band pass filter 330, where the first band pass filter 330 is adapted to pass lower frequencies X-Y MHz and higher frequencies Y-Z MHz, and the second band pass filter 350 is adapted to pass lower frequencies X-Y MHz and to exclude higher frequencies Y-Z MHz, where X<Y<Z.

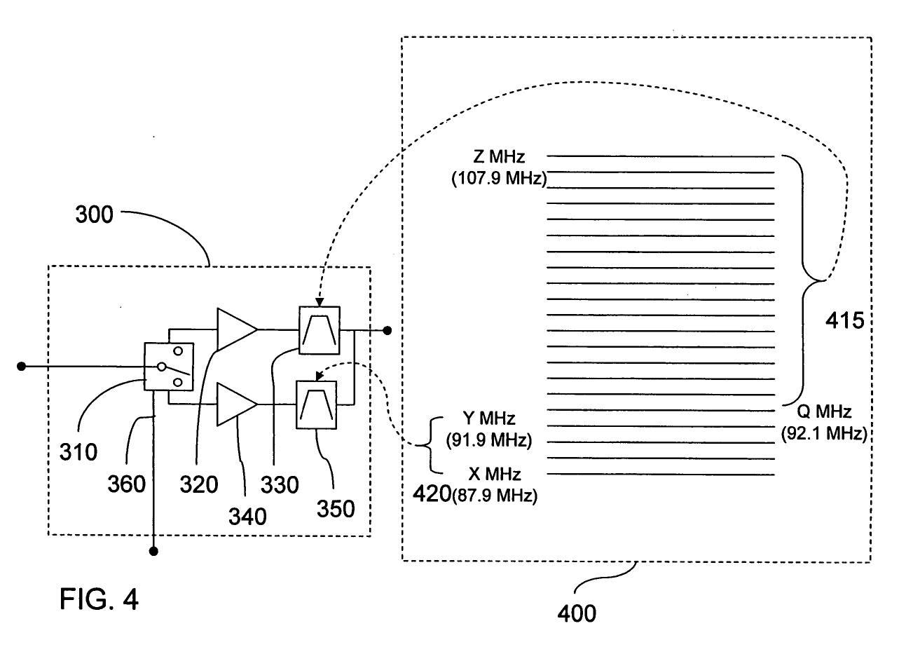

Alternately, as shown in FIG. 4, the first and second band pass filters 330, 350 may be adapted to pass adjacent higher frequencies Q-Z MHz and lower frequencies X-Y MHz, respectively, where X<Y<Q<Z. In other words, an upper limit Y MHz of the second radio frequency range 420 passed by the second band pass filter 350 corresponds with or is less than a lower limit Q MHz of the first radio frequency range 415 passed by the first band pass filter 330.

For example, the second radio frequency range 420 may be between frequencies centered about 87.9 MHz (X) and frequencies centered about 91.9 MHz (Y), or between about 87.8 MHz and about 92.0 MHz, which corresponds with the reserved or noncommercial FM band or Channels 200 through 220, and the first radio frequency range 415 may be between frequencies centered about 92.1 MHz (Q) and frequencies centered about 107.9 MHz (Z), or between about 92.0 MHz and about 108.0 MHz, which corresponds with the commercial FM band or Channels 221 through 300.

It is understood that the filter circuit 300 could be provided in any suitable architecture combining various features described above. For example, the filter circuit 300 could have the structure shown on the left side of FIG. 3, and could be adapted to pass frequencies as shown on the right side of FIG. 4. That is, the filter circuit 300 may be adapted to operate such that a signal passes only through the first band pass filter 330, or a signal passes first through the second band pass filter 350 and then passes through the first band pass filter 330 (left side of FIG. 3), where the first and second band pass filters 330, 350 may be adapted to pass adjacent higher frequencies Q-Z MHz and lower frequencies X-Y MHz, respectively, where X<Y<Q<Z (right side of FIG. 4).

Also, the present invention is directed to a method for receiving a radio signal comprising the steps of selectively connecting a first band pass filter between an input and a mixer when a tuner is tuned to a first radio frequency range and selectively connecting a second band pass filter between the input and the mixer when the tuner is tuned to a second radio frequency range. For example, the method for receiving a radio signal may comprise the steps of selectively connecting first band pass filter 330, between signal input 20 and FM mixer 140 when tuner 160 is tuned to first radio frequency range 410 or 415, and selectively connecting second band pass filter 350 between the input and the mixer when the tuner is tuned to second radio frequency range 420.

The present inventors have investigated the performance of a conventional radio receiver, for example a KENWOOD AM/FM DAB radio receiver, in a large metropolitan area. The present inventors have observed that in most directions from a public FM radio station transmitter the conventional radio receiver is able to receive a signal from the transmitter at a maximum distance of about 60 km (37 miles).

However, the present inventors observed that the maximum reception distance was reduced in a particular direction. In particular, it was observed that the particular direction of the reduction of the maximum reception distance was in the same direction as a transmitter for a strong commercial FM radio station. The strong signal from the commercial FM radio station was observed to suppress the weaker signal from the desired public FM radio station by desensitizing the radio receiver.

Specifically, a study was conducted in a large metropolitan area where five noncommercial stations were broadcasting in the reserved band, between about 87.9 MHz and 91.9 MHz. Two of these noncommercial stations were low power stations, that is less than 1 KW, and as low as 1 W. For one low power noncommercial radio station in the study, a desired-to-undesired ratio (D/U) of −40 dB was observed. Seven commercial high power stations, that is 22.5 to 43 KW, were broadcasting in the commercial band, between about 92.1 MHz and 107.9 MHz, within about 10 km of the low power stations. When using a conventional radio receiver relatively close to any of the seven commercial high power stations, that is within 1 to 2 km, a “kill zone” was observed where the signal from the noncommercial radio station transmitter can no longer reach the radio receiver. The relative strength of the strong commercial transmitter overpowers the weaker noncommercial transmitter, even though the commercial and noncommercial stations are broadcasting at different frequencies.

The desensitizing effect occurs in the radio receiver after the signal goes through the FM band pass (or band select) filter. In the above example, both stations are in the FM band, so the band pass filter (from 87.9 MHz to 107.9 MHz) is not equipped to improve the reception of the weaker signal from the desired public FM radio station. As stated above, prior art radio receivers may be equipped with a filter for a desired station, but such filtering occurs after the first mixer, amplifier and AGC stages, that is after IF downconversion. Although it is possible to improve the performance of a radio receiver by filtering out an undesired station, it is not practical or economical. There are 101 possible FM station frequency allocations in the U.S. FM band, and it is not feasible to provide a filter for each station in the radio receiver.

Also, the present inventors have observed that a brute force approach of increasing the power of a broadcasting station is often seen as a solution to the above-noted problem. Increasing the power of a station is expensive and often not possible for public broadcasters such as local colleges. More importantly, the FCC already limits the power of many stations in order to limit interference to nearby stations on the same or adjacent frequencies. As commercial FM radio stations continue to increase the power of their broadcast signals, public FM radio stations are unable to make similar increases in broadcasting power, and the above-referenced problems of FM radio receiver desensitization and loss of broadcasting coverage for public FM radio stations are exacerbated. The present invention, as described in detail above, reduces undesired signals and improves the D/U ratio.

The present invention has been described in terms of presently preferred embodiments so that an understanding of the present invention can be conveyed. The present invention should therefore not be seen as limited to the particular embodiments described herein. Rather, all modifications, variations, or equivalent arrangements that are within the scope of the attached claims should be considered to be within the scope of the invention.

1. A radio receiver comprising:
a first band pass filter selectively electrically connected between an input and a mixer when a tuner is tuned to a first radio frequency range, and
a second band pass filter selectively electrically connected between said input and said mixer when said tuner is tuned to a second radio frequency range.

2. The radio receiver of claim 1, wherein said first and second band pass filters operate before an intermediate frequency stage of said radio receiver.

3. The radio receiver of claim 1, wherein said first radio frequency range passed by said first band pass filter is directly adjacent to said second radio frequency range passed by said second band pass filter.

4. The radio receiver of claim 1, wherein said first radio frequency range passed by said first band pass filter at least partially overlaps with said second radio frequency range passed by said second band pass filter.

5. The radio receiver of claim 1, wherein said second band pass filter is adapted for a reserved band.

6. The radio receiver of claim 1, wherein said second band pass filter is adapted to filter out commercial radio broadcasting.

7. The radio receiver of claim 1, wherein said radio receiver further comprises:
a tuner operatively connected to said first and second band pass filters and which operates such that said first band pass filter selectively electrically connects between said input and said mixer when said tuner is tuned to said first radio frequency range, and such that said second band pass filter selectively electrically connects between said input and said mixer when said tuner is tuned to said second radio frequency range.

8. A filter circuit for an FM radio receiver comprising:
a first radio frequency filter for passing a first radio frequency range;
a second radio frequency filter for passing a second radio frequency range different from said first radio frequency range; and
a control circuit operatively connected with said first radio frequency filter and said second radio frequency filter for inserting said first radio frequency filter into a signal path when the FM radio receiver is tuned to a frequency in said first radio frequency range and for inserting said second radio frequency filter into said signal path when the FM radio receiver is turned to a frequency in said second radio frequency range.

9. The filter circuit of claim 8, wherein said first and second radio frequency filters operate before an intermediate frequency stage of said filter circuit.

10. The filter circuit of claim 8, wherein said first radio frequency range passed by said first radio frequency filter is directly adjacent to said second radio frequency range passed by said second radio frequency filter.

11. The filter circuit of claim 8, wherein said first radio frequency range passed by said first radio frequency filter at least partially overlaps with said second radio frequency range passed by said second radio frequency filter.

12. The filter circuit of claim 8, wherein said second radio frequency filter is adapted for a reserved band.

13. The filter circuit of claim 8, wherein said second radio frequency filter is adapted to filter out commercial radio broadcasting.

14. The filter circuit of claim 8, wherein said control circuit comprises a switch electrically connected between an RF signal source and each of an input of said first radio frequency filter and an input of said second radio frequency filter.

15. A receiver for receiving an FM radio signal comprising:
a first means for filtering said FM radio signal selectively electrically connected between a means for inputting said FM radio signal and a means for mixing said FM radio signal when a means for tuning said receiving means is tuned to a first radio frequency range, and
a second means for filtering said FM radio signal selectively electrically connected between said means for inputting said FM radio signal and said means for mixing said FM radio signal when said means for tuning said receiving means is tuned to a second radio frequency range.

16. The receiver of claim 15, wherein said first and second means for filtering said FM radio signals operate before an intermediate frequency stage of said means for receiving an FM radio'signal.

17. The receiver of claim 15, wherein said first radio frequency range passed by said first means for filtering said FM radio signal is directly adjacent to said second radio frequency range passed by said second means for filtering said FM radio signal.

18. The receiver of claim 15, wherein said first radio frequency range passed by said first means for filtering said FM radio signal at least partially overlaps with said second radio frequency range passed by said second means for filtering said FM radio signal.

19. The receiver of claim 15, wherein said second means for filtering said FM radio signal is adapted for a reserved band.

20. The receiver of claim 15, wherein said second means for filtering said FM radio signal is adapted to filter out commercial radio broadcasting.
